(19) United States
(12) Patent Application Publication
(10) Pub. No.: US 2006/0044782 A1
(43) Pub. Date: Mar. 2, 2006

(54) Light-storing safety device

(76) Inventor: Robin Hsu, Taipei City (TW)

Correspondence Address: BRUCE H. TROXELL, SUITE 1404, 5205 LEESBURG PIKE, FALLS CHURCH, VA, 22041, US

(21) Appl. No.: 11/050,845

(22) Filed: Feb. 7, 2005

(30) Foreign Application Priority Data
Aug. 31, 2004 (TW) 093213767
Dec. 24, 2004 (TW) 093220880

(51) Int. Cl. F21K 2/00

(52) U.S. Cl. 362/34

(57) ABSTRACT

The present invention discloses a light-storing safety device comprising a substrate and a plurality of light storing units, characterized in which the light-storing units are arranged at the location on the photo-reflective, photopermeable or light-emitting surface of substrate for display of text or graphic. Through such structure, the light-storing unit can absorb and store light source under the radiation of sunlight, car lamp, streetlight or other light sources or through the luminophor configured on its back. In the absence of external light source to project on such device, the light-storing unit on the substrate of the device provides an “active” light-emitting effect. In contrast to conventional substrate that offers only “passive” light-emitting or photopermeable effect, the present invention offers the same luminous display effect with or without the presence of external light source and may be applied to address the drawback of conventional devices that are unable to provide the same functions of giving direction or warning to other road users as to drivers of motor vehicles. Such device may also be used in signs for emergency exit to make them work better in terms of safety.

### BACKGROUND OF INVENTION

1. Field of the Invention

The present invention relates to a light-storing safety device, particularly a kind of light-storing safety device having a plurality of light-storing units with specific sizes and specific density arranged on the photo-reflective, photopermeable or luminescent surface of substrate that illuminate with or without the presence of external light source.

2. Description of the Prior Art

Along with technological development and progress, many innovative technologies have been applied to products used in daily lives to bring convenience to people. In the example of directional signs, the most commonly seen are outdoor street signs and indoor emergency directional signs (e.g. direction of exit, emergency exit, etc.). Street signs in the early days were typically street nameplates with characters on it that is hardly legible at night. The technological progress brought about the application of reflector sheet to street signs. Such reflector sheet as shown in FIG. 1 consists mainly of a reflective layer A with surface coated in sequence a layer of glass beads B and a transparent layer C. In addition, on the surface of transparent layer C, another colored transparent layer D (as shown in FIG. 2) is coated around the periphery of texts to be displayed. By adhering such reflector sheet on street nameplate, car or motorcycle drivers can see clearly the characters or pattern on the plate when the light projected from the headlight penetrates transparent layer C and emits reversibly through the recurrent reflection of glass beads B and reflective layer A, thus offering better effect in terms of direction and safety. Although the reflector described above in general offers good photo-reflecting effect and has been widely applied in all kinds of street signs, street nameplates or warning products, it still has some deficiencies that warrant improvement efforts. When reflectors are used in road signs on highways where road users are drivers, there is sufficient external light source for the reflector to work. But if the reflectors are used in signs posted on city streets or remote mountainous roads, their effect is much diminished in darker area of the city or on countryside industrial roads. As the users of those roads include drivers of motor vehicles as well as pedestrians and bicyclists, the latter cannot provide sufficient external light source like drivers of motor vehicles to let the reflector work and show the patterns thereon. That means, conventional reflectors work better for drivers of motor vehicles only, but fail to provide expected function of giving directions to other road users, such as pedestrians and bicyclists. On some remote roads in the outskirts of city, the lighting fixture is inadequate to begin with. If the road condition ahead is unclear and road signs or warning signs on roadside traffic light, poles, pier or electrical box cannot effectively catch the attention of road users, accident is prone to happen, which sometimes ends with regrettable consequences.

Emergency directional devices E installed indoor are meant to provide the function of guiding people trapped in a building to escape exit when the power is cut off in an accident (e.g. earthquake or fire). Thus the most basic requirement for such device is that it can actively emit light in the absence of power supply and give directions. Currently used emergency directional devices E, be it an emergency lighting, exit direction light, or other directional signs for escape, consist of at least an active luminophor F, a photopermeable sign plate G with pattern printed thereon and standby power supply H, wherein the photopermeable sign plate G is arranged anterior to the active luminophor F (FIG. 3). When the power supply to a building is disrupted, the standby power supply H will activate the luminophor F to provide proper illumination or the light from the active luminophor F can penetrate the photopermeable sign plate G to provide luminous guidance. But in the aforesaid emergency directional device E, the standby power supply H is a battery, which can provide emergency power for illumination. But it is relatively costly and bulky. Its service life is also limited as the so-called “battery memory effect” produced in the continuous cycle of charge and discharge eventually reduces its storage capacity. If the battery is not inspected or replaced periodically, which adds to the burden of maintenance personnel, it might fail to work when accident happens, becoming a significant loophole in safekeeping personal safety.

### SUMMARY OF INVENTION

The main object of the present invention is to provide a light-storing safety device comprising a substrate and a plurality of light storing units, characterized in which the light-storing units with specific sizes are arranged in specific density at the location on the light-reflecting, photopermeable or luminescent surface of substrate for display of text or graphic. Through such structure, the invention can use reflector with light-reflecting effect as substrate and apply to outdoor street signs where light-storing unit can absorb and store light source during daylight or at nighttime under the radiation of vehicle headlight. As such, at nighttime, the device offers “passive” light-emitting effect through the working of conventional reflector sheet, and in the absence of external light source, its light-storing unit on the substrate of the device provides an “active” light-emitting effect. In contrast to conventional reflector that offers only “passive” light-emitting or photopermeable effect, the present invention offers the same luminous display effect with or without the presence of external light source and may be applied to address the drawback of conventional devices that are unable to provide the same functions of giving direction or warning to other road users as to drivers of motor vehicles.

Another object of the present invention is to provide a light-storing safety device, wherein the substrate may be an active luminophor, a photopermeable element or a reflector sheet with photopermeable effect which can accept light source projected from the back, store it and release the stored light energy when needed.

Yet another object of the present invention is to provide a light-storing safety device, wherein the light emitted from the light-storing unit coated on the surface of reflector has color similar to that at the place where it is disposed.

A further object of the present invention is to provide a light-storing safety device, wherein the features of small size, easy to manufacture, low cost and unlimited service life of its light-storing unit provide an excellent replacement or aid for the light-emitting effect, thereby effectively avoiding the drawback of storage battery that might not work when needed.

### BRIEF DESCRIPTION OF THE DRAWINGS

The details of the present invention will be more readily understood from a detailed description of the preferred embodiments taken in conjunction with the following figures.

FIG. 1 is a sectional view of conventional reflector.

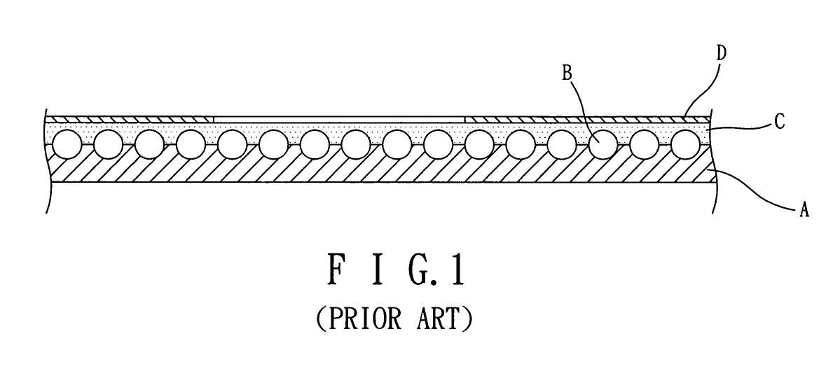

FIG. 2 is a front view of conventional reflector.

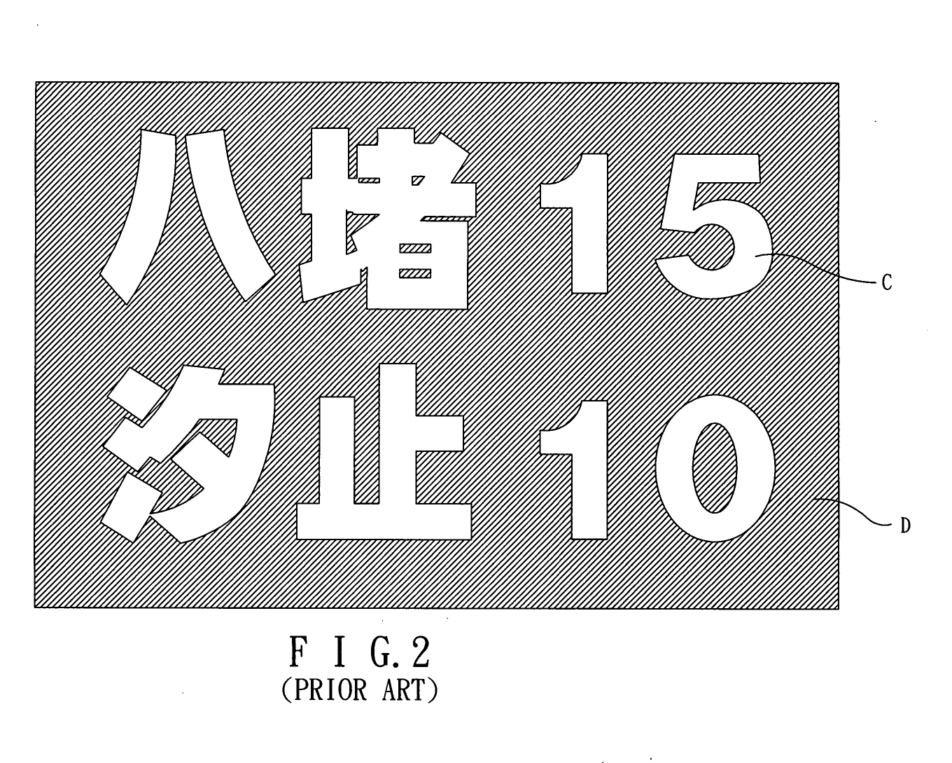

FIG. 3 is a perspective view of conventional emergency directional device.

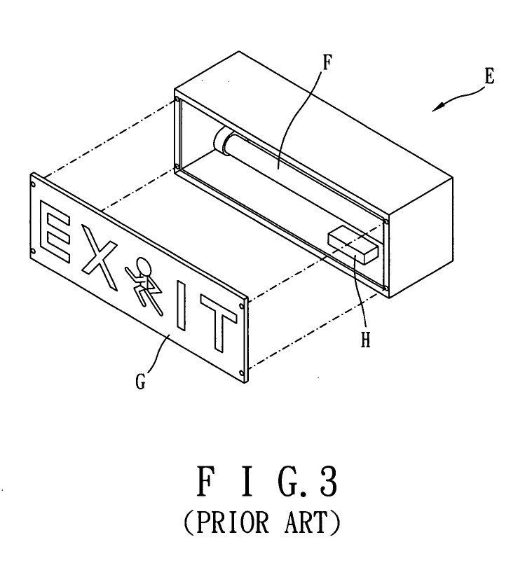

FIG. 4 is an exploded view of the present invention.

FIG. 5 is an exploded view of another embodiment of the present invention.

FIG. 6 is a sectional view of another embodiment of the present invention.

FIG. 7 is a perspective view of the present invention applied in an emergency directional device.

### DETAILED DESCRIPTION

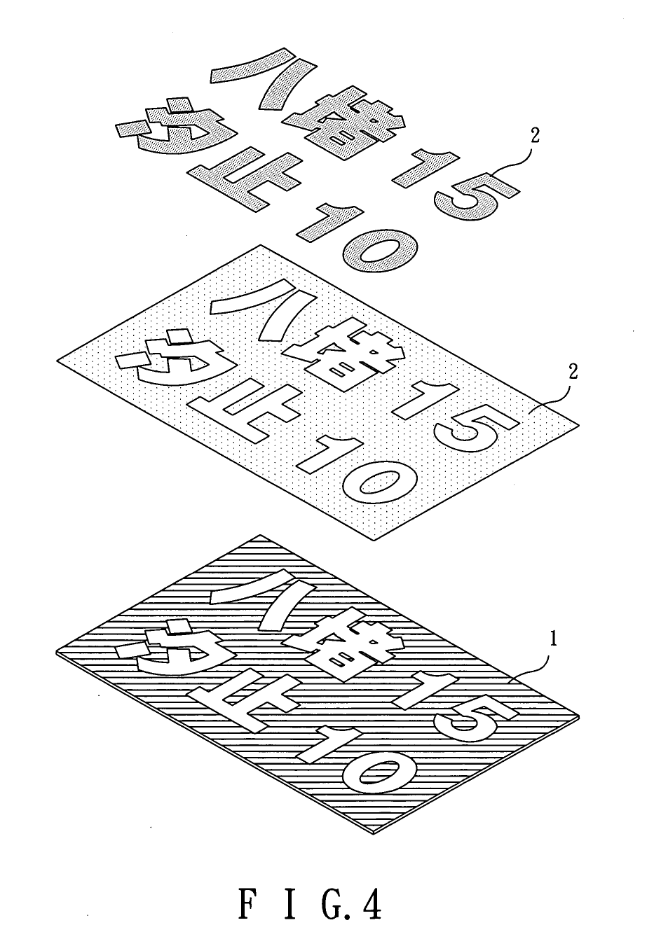

Referring to FIG. 4 which show the exploded view of the light-storing safety device according to the present invention, the light-storing safety device disclosed herein comprises a substrate 1 and a plurality of light-storing units 2, characterized in which light-storing units 2 with specific sizes and specific density are arranged at the location on the surface of substrate 1 for display of text or graphic. Through the aforesaid structure, light-storing units 2 can receive and store external light energy during normal use and release the light energy when the external light source disappears to attain the effect of active illumination. Other advantages of the present invention are small volume, low cost and simple manufacturing process.

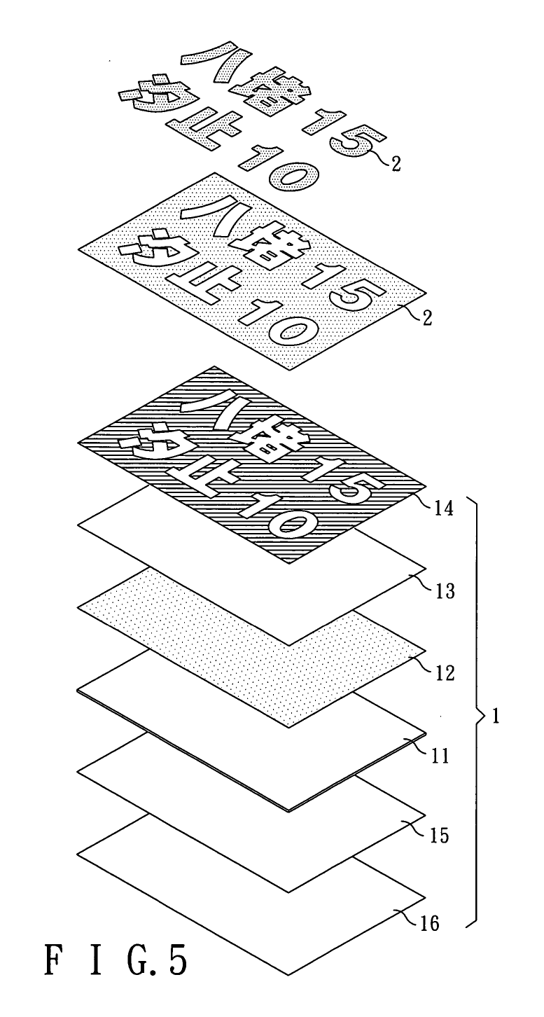

In the aforesaid structure, the light-storing units 2 are phosphorescent pigment that emits phosphorescence, which can be coated on the surface of substrate 1 by means of screen printing (FIG. 5). As such, its manufacturing process is simple and allows broader selection of substrate structure 1. Its cost is also relatively cheap, making it highly competitive in commercial applications.

The light-storing unit 2 arranged on the surface of substrate 1 preferably has a size ranging between 0.1 mm˜20 mm and its density at the display portion preferably ranges between 30%˜70%. Through proper control of the size and distribution density of light-storing units 2, we can effectively control and adjust the light-reflecting and light-storing effect of the invention.

The present invention has many practical applications and achieve excellent effect in a wide variety of products. A few preferred embodiments accompanied by drawings are illustrated below. First of all, the invention can be used in outdoor road signs, in which a reflector with light-reflecting effect is used as substrate 1. Through the light-storing units 2 on the reflector 1, the device can absorb and store light source under daylight or at nighttime under the radiation of headlight. As such, at nighttime, the device offers “passive” light-emitting effect through the working of conventional reflector, and in the absence of external light source, its light-storing unit 2 on the substrate 1 of the device provides an “active” light-emitting effect to give direction or warning to road users other than drivers of motor vehicles. In contrast to conventional reflector that offers only “passive” light-emitting effect, the present invention offers the same luminous display effect with or without the presence of external light source that truly improves the drawback of conventional devices that are unable to provide the same functions of giving direction or warning to other road users as to drivers of motor vehicles.

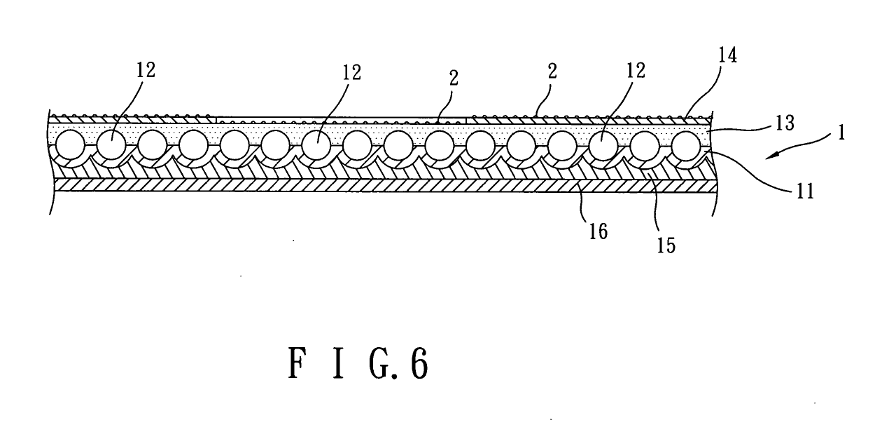

In the aforesaid structure, there are a variety of options for the structure of reflector. In addition to reflector sheet, a kind of self-adhesive reflector film may be used as well. A few examples of commonly used reflector film are presented below. Referring to FIG. 5 and FIG. 6 which show respectively the exploded view and sectional view of another embodiment of the invention, the reflector film consists mainly of a reflective layer 11 with surface coated in sequence a layer of glass beads 12 and transparent layer 13, where on the surface of transparent layer 13, another colored transparent layer 14 is coated around the periphery of texts to be displayed, and the other surface of reflective layer 11 is painted with a layer of adhesive 15 with release liner 16 thereon. With the arrangement of glass beads 12 and reflective layer 11, light coming from outside is recurrently reflected to achieve light-reflecting effect.

To make sure the present invention can emit light “passively” through reflector or “actively” through light-storing unit to achieve the same effect of giving direction or warning, the light emitted from light-storing unit 2 disposed on the surface of reflector 1 has similar color to that at the location where it is disposed. This design gives road users the same visual perception regardless whether the light is emitted passively or actively, so there won't be any adaptation problem to the viewers.

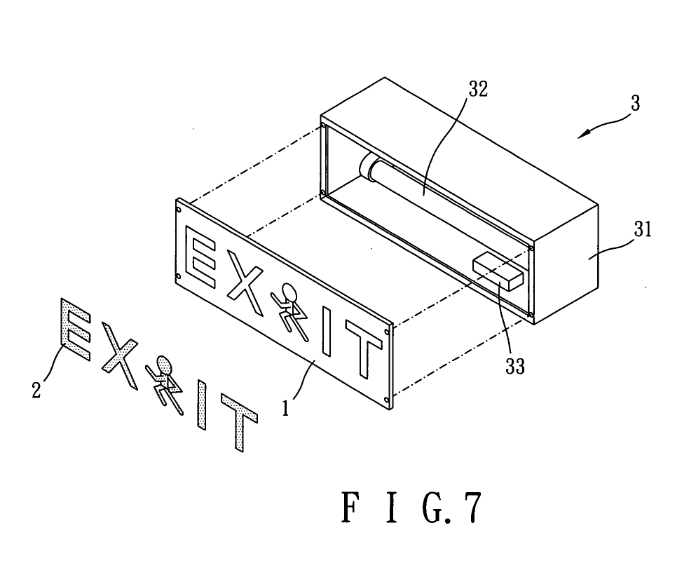

Referring to FIG. 7 which shows the perspective view of another embodiment, in which the present invention is used in indoor emergency directional device 3, wherein photopermeable material is used for substrate 1, and on which, there prints a layer of photopermeable text or pattern. The structure described above can be mounted in the emergency directional device 3, which further includes a casing 31, an active luminophor 32 and a standby power supply 33. The present invention may be arranged in front of active luminophor 32 and secured to the casing 31. Ordinarily the light from the active luminophor 32 can pass through the photopermeable substrate 1 printed with pattern or text to let the substrate 1 clearly display the directional text or pattern, while light-storing units 2 disposed on the other side of substrate 1 can absorb and store light energy. Once the building has power outage, the active luminophor 32 can use the standby power supply 33 to continue to emit light, and the design of light-storing units 2 will release the stored light energy when the standby power supply 33 fails to prolong display time and give people trapped in the building more time to get to the escape exit.

Aside from using photopermeable material as substrate 1, the present invention can also utilize reflector with photopermeable effect. It means light from the back can penetrate, while light from the front is reflected back to the origin of light source through recurrent reflection. The substrate 1 can also be a material with light-emitting effect. It means the device of the present invention can have light-storing units 2 directly arranged on the surface of active luminophor 32 to achieve the same effect. The active luminophor 32 can be a light bulb or tube, or the energy-saving light-emitting diode (LED) display or electroluminescent cold light plate.

By the descriptions above, it is clear that by arranging a plurality of light-storing units in specific density at the location on the photo-reflective, photopermeable or light-emitting surface of substrate for display of text or pattern, the device can produce the same luminous display effect with or without the presence of external light source. On the one hand, it effectively addresses the drawback of reflector-based road signs that are unable to provide the same functions of giving direction or warning to other road users as to drivers of motor vehicles. On the other hand, when the present invention is applied in emergency directional devices, it offers good light-storing effect and reliable source of light for luminous display of escape guide when standby power supply fails.

Preferred embodiments of the present invention have been disclosed, which are not meant to limit the scope of the invention. All modifications and alterations without departing from the spirits of the invention, such as changes to the structure of reflector, shall remain within the protected scope and claims of the invention.

In summary, the light-storing safety device disclosed in the present invention features small volume, simple process and low cost. It also possesses “active” and “passive” illumination, offering the same luminous direction or warning effect with or without the presence of external light source. It effectively improves the drawback of conventional “passive light-emitting” reflector that fails to work in the absence of external light source and provides the same function of giving direction or warning to road users other than drivers of motor vehicles (e.g. pedestrians and bicyclists), hence making it a better safety device.

What is claimed is:

1. A light-storing safety device, comprising:
a substrate made of reflector having light-reflecting effect; and,
a plurality of light-storing units arranged on a surface of said substrate.

2. The light-storing safety device according to claim 1, wherein said light-storing unit is a phosphorescent pigment.

3. The light-storing safety device according to claim 1, wherein said substrate made of reflector is disposed of a photopermeable layer of text or pattern.

4. The light-storing safety device according to claim 1, wherein the size of a single light-storing unit ranges preferably between 0.1 mm and 20 mm.

5. The light-storing safety device according to claim 1, wherein the density of light-storing units preferably represents 30%˜70% of the portion to be displayed.

6. The light-storing safety device according to claim 1, wherein said reflector is a reflector film with adhesive back.

7. The light-storing safety device according to claim 6, wherein said reflector film consists of a reflective layer coated in sequence with a layer of glass beads and a transparent layer; a layer of colored transparent layer is coated around the periphery of texts to be displayed on the surface of transparent layer, and the other surface of reflective layer is painted with a layer of adhesive with release liner thereon.

8. A light-storing device which is mountable in front of a light-emitting emergency directional device, comprising:
a substrate made of photopermeable material; and,
a plurality of light-storing units arranged on a surface of said substrate.

9. The light-storing safety device according to claim 8, wherein said light-storing unit is a phosphorescent pigment.

10. The light-storing safety device according to claim 8, wherein said substrate made of reflector is disposed of a photopermeable layer of text or pattern.

11. The light-storing safety device according to claim 8, wherein the size of a single light-storing unit ranges preferably between 0.1 mm and 20 mm.

12. The light-storing safety device according to claim 8, wherein the density of light-storing units preferably represents 30%˜70% of the portion to be displayed.

13. The light-storing safety device according to claim 8, wherein said light-emitting emergency directional device further comprises an active luminophor and a casing body, where said active luminophor is arranged inside the casing body, while the substrate is adjoined to the casing body and disposed in front of the active luminophor.

14. The light-storing safety device according to claim 8, wherein said substrate is a photopermeable reflector.

15. A light-storing safety device comprising:
a substrate made of active luminophor; and,
a plurality of light-storing units arranged on a surface of said substrate.

16. The light-storing safety device according to claim 15, wherein said light-storing unit is a phosphorescent pigment.

17. The light-storing safety device according to claim 15, wherein said substrate is a light-emitting diode display.

18. The light-storing safety device according to claim 15, wherein said substrate is a cold-light plate.

19. The light-storing safety device according to claim 15, wherein the size of a single light-storing unit ranges preferably between 0.1 mm and 20 mm.

20. The light-storing safety device according to claim 15, wherein the density of light-storing units preferably represents 30%˜70% of the portion to be displayed.
